(19) United States
(12) Patent Application Publication
(10) Pub. No.: US 2015/0171580 A1
(43) Pub. Date: Jun. 18, 2015

(54) CORD WITH INTERCHANGEABLE HEADS

(71) Applicant: Craig FURST, Los Angeles, CA (US)

(72) Inventor: Craig FURST, Los Angeles, CA (US)

(21) Appl. No.: 14/133,452

(22) Filed: Dec. 18, 2013

(51) Int. Cl. H01R 27/00

(52) U.S. Cl. CPC H01R 27/00

(57) ABSTRACT

In embodiments, a base cord, comprises: an insulating cord body with a first and second ends; a plurality of conducting wires running within the cord body from the first end to the second end; a female terminal comprising a plurality of different sets of conducting holes, with each respective different set of conducting holes connected to a different set of the conducting wires, and adapted for connection to an associated male terminal head with male conducting posts that fit within the conducting holes of the respective set, wherein a first one of the sets of conducting holes has at least one different shape compared to shapes of a second one of the sets of conducting holes. In embodiments, a kit may comprise the base cord and one or more interchangeable heads.

### BACKGROUND OF THE INVENTION

The present invention relates to the field of electrical cords.

### BRIEF SUMMARY OF THE INVENTION

Embodiments of the invention may comprise a base cord, comprising: an insulating cord body with a first and second ends; a plurality of conducting wires running within the cord body from the first end to the second end; wherein each of the electrical terminals is either female or male in configuration and comprises a plurality of different sets of one or more conducting holes or conducting posts, with each respective different set of one or more conducting holes or conducting posts connected to a different set of one or more of the conducting wires, wherein a first one of the sets of one or more conducting holes or conducting posts has at least one different shape compared to one or more shapes of a second one of the sets of one or more conducting holes or conducting posts.

In other embodiments, both the first and the second ends may have a male terminal thereon.

In embodiments, both the first and the second ends may have the female terminal thereon.

In embodiments, the at least one female terminal may comprise an internally threaded cylinder rotatably attached to an end of the female terminal, and may be adapted to be rotated to make threaded engagement with a threaded outer perimeter of the male terminal head.

In embodiments, at least one of the conducting wires is of a different type compared to the other conducting wires. In embodiments, the different type may comprise a different wire gauge. In embodiments, the different type may be one selected from the group of USB power wire, ground wire, A/C power wire, telephony connectors, audio connectors, video connectors, tire wire, to name just a few of the variety of possible connectors. The type of connector is not limiting on the invention.

In embodiments, a kit consistent with the invention may comprise: a base cord, comprising: an insulating cord body with a first and second ends; a plurality of conducting wires running within the cord body from the first end to the second end; a female terminal at least at one of the first and second ends of the cord body, wherein the at least one female terminal comprises a plurality of different sets of one or more conducting holes, with each respective different set of one or more conducting holes connected to a different set of one or more of the conducting wires, wherein a first one of the sets of one or more conducting holes has at least one different shape compared to one or more shapes of a second one of the sets of one or more conducting holes, and a plurality of interchangeable heads, comprising: a first interchangeable head comprising: an insulating first cord body with a first and second ends; one or more conducting wires running within the first cord body from the first end to the second end; a first male terminal head at one of the ends of the insulating cord body, with a set of one or more male conducting posts of a first one or more shapes adapted to mate with the one or more conducting holes of the first set of conducting holes in the female terminal of the base cord, wherein each conducting wire connects to a different one of the one or more male conducting posts; a second terminal head that is male or female at the other of the ends of the insulating cord body; a second interchangeable head comprising: an insulating second cord body with a first and second ends; one or more conducting wires running within the second cord body from the first end to the second end; a third male terminal head at one of the ends of the insulating cord body, with a set of one or more male conducting posts of a second one or more shapes adapted to mate with the one or more conducting holes of the second set of conducting holes in the female terminal of the base cord, wherein each conducting wire connects to a different one of the one or more male conducting posts; and a fourth terminal head that is male or female at the other of the ends of the insulating cord body.

In embodiments, the plurality of interchangeable heads may comprise a shape selected from the group of a USB connector, an A/C power connector, telephony connectors, audio connectors, video connectors, fire wire, to name just a few of the possible connectors. The type of connector is not limiting on the invention.

In embodiments, the second terminal head may be a male terminal head with a set of one or more male electrical connectors with a third shape that is different from the first shape.

In embodiments, a kit consistent with the invention may comprise: a base cord, comprising: an insulating cord body with a first and second ends; a plurality of conducting wires running within the cord body from the first end to the second end; an electrical terminal at each of the first and second ends of the cord body, wherein one of the electrical terminals is either female or male in configuration and comprises a plurality of different sets of one or more conducting holes or conducting posts, with each respective different set of one or more conducting holes or conducting posts connected to a different set of one or more of the conducting wires, wherein a first one of the sets of one or more conducting holes or conducting posts has at least one different shape compared to one or more shapes of a second one of the sets of one or more conducting holes or conducting posts, and a single element comprising a plurality of interchangeable heads, with comprising: a first interchangeable head comprising: an insulating first cord body with a first and second ends; one or more first conducting wires running within the first cord body from the first end to the second end; a first terminal head at one of the ends of the insulating first cord body, with a set of one or more male conducting posts or female conducting holes of a first set one or more shapes, wherein each of the male conducting posts or female conducting holes connects to a different one of the first conducting wires; a second interchangeable head comprising: an insulating second cord body with a first and second ends; one or more second conducting wires running within the second cord body from the first end to the second end; a second terminal head at one of the ends of the insulating second cord body, with a set of one or more male conducting posts or female conducting holes of a second set one or more shapes that has at least one different shape compared to one or more shapes of the first one of the sets of one or more conducting holes or conducting posts, wherein each of the male conducting posts or female conducting holes connects to a different one of the second conducting wires; a single connector that receives the first set of one or more conducting wires and the second set of one or more conducting wires and comprises a single third male or female electrical terminal with a first set of one or more conducting holes or conducting posts and a second set of one or more conducting holes or conducting posts, wherein the first set of one or more conducting holes or conducting posts has at least one different shape compared to the one or more shapes of the second set of one or more conducting holes or conducting posts, wherein the first set of one or more conducting holes or conducting posts in the single interchangeable head is adapted to mate with the first set of one or more conducting holes or conducting posts in the base cord, and the second set of one or more conducting holes or conducting posts in the single interchangeable head is adapted to mate with the second set of one or more conducting holes or conducting posts in the base cord.

### BRIEF DESCRIPTION OF THE DRAWINGS

FIGS. 1A and 1B illustrate an embodiment of a base cord consistent with the invention.

FIG. 2 is an embodiment of a multi-cord consistent with the invention.

FIG. 3 is an embodiment of an interchangeable head consistent with the invention.

FIG. 4 is another embodiment of an interchangeable head consistent with the invention.

FIG. 5 is third embodiment of an interchangeable head consistent with the invention.

FIG. 6 is fourth embodiment of an interchangeable head consistent with the invention.

FIG. 7 illustrates a group different interchangeable heads consistent with the invention.

FIGS. 8A and 8B illustrate another embodiment of illustrating a two-headed terminal attachment.

FIGS. 9A and 9B illustrate an embodiment of a base cord with a terminal for at least a two-headed attachment.

### DETAILED DESCRIPTION OF EMBODIMENTS

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

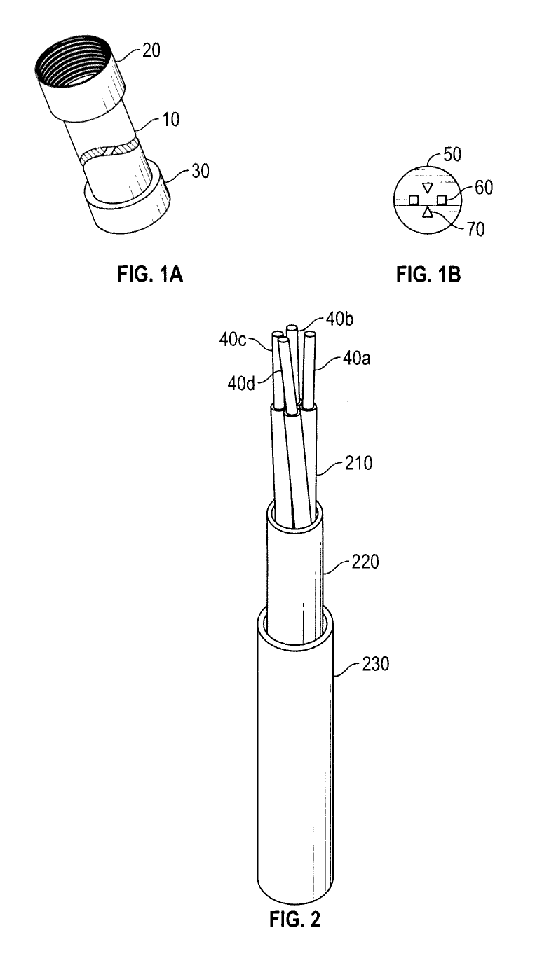

Referring to FIGS. 1A and 1B, an embodiment of a base cord consistent with the invention is shown. The base cord comprises an insulating cord body 10 with a first end 20 and a second end 30. The base cord will have multiple conducting wires running through the cord body 10. In embodiments, the base cord may have a female conducting terminal and a male conducting terminal at the respective ends of the base cord. In embodiments, the base cord may female conducting terminals at both of the ends of the base cord. In embodiments, the base cord may have male conducting terminals at both of the ends of the base cord.

An embodiment of the base cord illustrating the multiple wires is shown in FIG. 2. FIG. 2 illustrates as an example, four conducting wires 40A, 40B, 40C, and 40D. In embodiments, the wires may have individual insulation 210. In embodiments, there may be an internal shield or barrier 220. In embodiments, the cord body may comprise an integral (not a cover) decorative outer surface 230. Embodiments of integral decorative designs are disclosed in design application “DECORATIVE CONDUCTIVE CORD WITH INTEGRAL DESIGN” by Craig Furst, Ser. No. 29/476,940, filed on Dec. 18, 2013. The disclosures of these design application serial number are hereby incorporated by reference in their entirety for all purposes. The decorative design 230 may be made of a variety of different materials including silk, braided rope, “Scrunchee” hair tie look, corduroy, jeans material, carbon fiber, fiberglass, wood beads (walnut, oak, burlwood, maple, etc.), clear plastic, naugahide, alligator, crocodile, snake skin cords, leopard print, zebra print, army prints, navy prints, strips, solid colors, missoni/Paul Smith style prints, plaid patterns, rocks/crystals, brushed aluminum beads, copper beads, bronzed metal beads, quilted style cord with many materials randomly fused, licensed printed cords for sports, games, Disney, collages, etc., Carrera marble, rubber bands, to name a few.

Referring to FIG. 1B, a female terminal 50 is illustrated as an embodiment for one of the first and second ends of the cord body. The female terminal 50 comprises a plurality of different sets of one or more conducting holes, with each respective different set of one or more conducting holes connected to a different set of one or more of the conducting wires, and adapted for mating with an associated male terminal head with one or more male electrical connectors/conducting posts, that fit within the one or more conducting holes of the respective set. In embodiments, one set of one or more conducting holes comprises the square conducting holes 60 of FIG. 1B. In embodiments, another set of one or more conducting holes comprises the triangular conducting holes 70 of FIG. 1B. The shape of the conducting holes is not limiting on the invention.

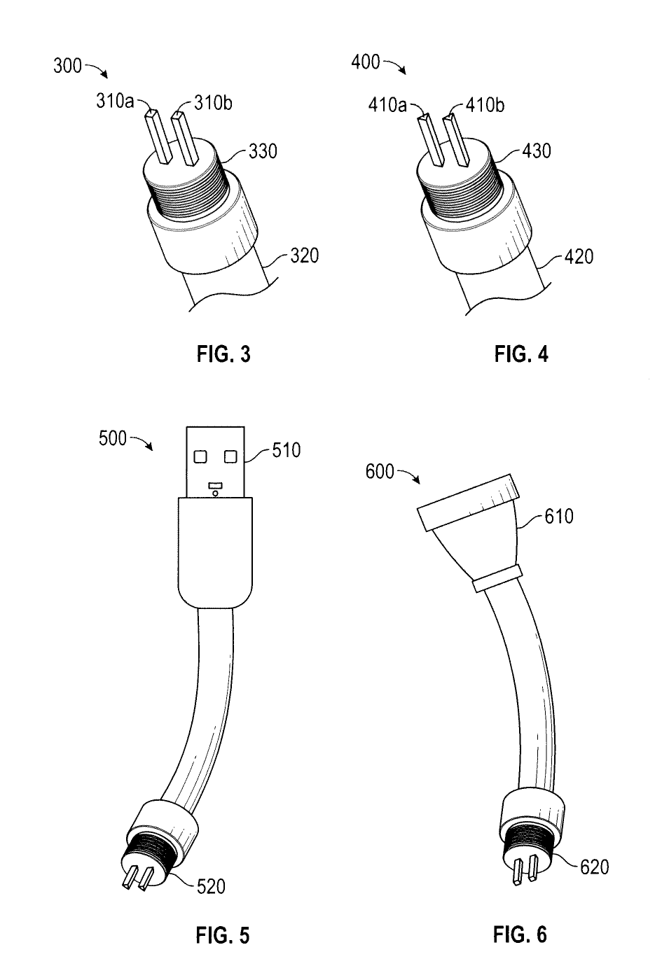

Referring to FIG. 3, in embodiments a first male interchangeable head 300 may comprise a terminal 330 at one end thereof with a set of one or more male conducting connectors or posts 310A and 310B of a first shape adapted to mate with the one or more conducting holes of the respective sets of conducting holes in the female terminal of the base cord, e.g., the square shaped conducting holes 60 of FIG. 1B. The interchangeable head 300 may further comprise an insulating cord body 320 with a first and second ends, with one or more conducting wires (not shown in the figure) running through the cord body. In embodiments, each of the conducting wires connects to a different one of the one or more male conducting posts 310A, 310B. A second terminal head (not shown) at another end of the interchangeable head may comprise either a male or a female electrical terminal.

In embodiments, the shapes for each of the interchangeable heads is different and may be used for different applications. Referring to FIG. 4, in embodiments a second male interchangeable head 400 may comprise a terminal 430 at one end thereof with a set of one or more male electrical connectors or studs 410A and 410B of a second shape that fit within the one or more conducting holes of another of the respective sets of conducting holes, e.g., the triangular shaped conducting holes 70. The interchangeable head 300 further comprises an insulating cord body 420 with a first and second ends, with one or more conducting wires (not shown in the figure) running through the cord body. In embodiments, each of the conducting wires connects to a different one of the one or more male terminal heads 41 OA, 410B. A second terminal head (not shown) at the other end of the interchangeable head may comprise either a male or a female electrical terminal. In embodiments, one of the shapes may be selected from the group of a USB connector, and an A/C power connector.

Referring to FIG. 5, embodiments of an interchangeable head 500 is shown with a USB power terminal 510 at one end thereof, and a male connector 520 at another end thereof for mating with the base cord.

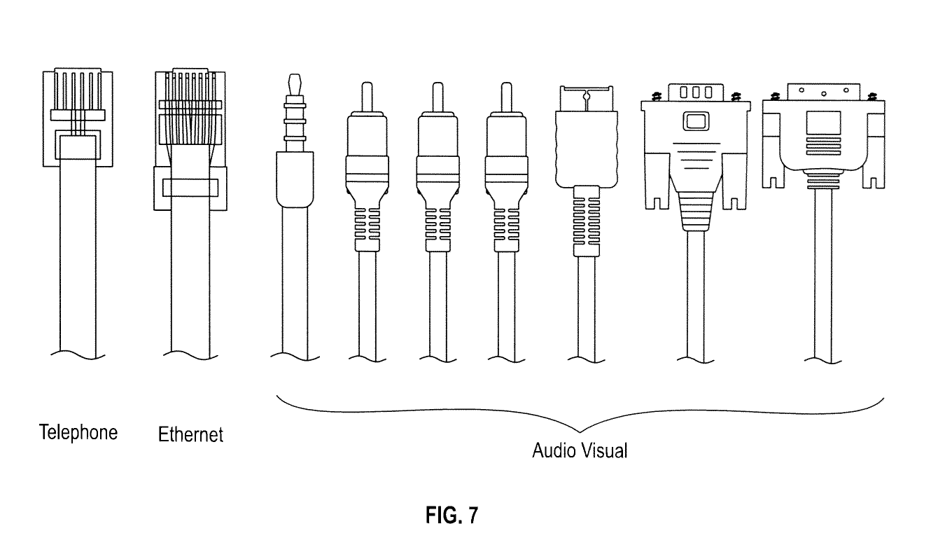

Referring to FIG. 6, embodiments of an interchangeable head 600 is shown with a female A/C power terminal 610 at one end thereof, and a male terminal 620 at another end thereof for mating with the base cord.

Referring to FIG. 7, embodiments of a group of different interchangeable heads is illustrated, comprising a telephone terminal, an Ethernet terminal, and a variety of different audio visual terminals. The invention is not limited in the type of terminal.

Referring to FIGS. 8A and 8B, embodiments a multi-headed interchangeable head 800 is illustrated. A first one of the heads comprises a terminal 810 at one end of an insulating cord 820. In the embodiment illustrated, terminal 810 is a female terminal for A/C power. However, in embodiments, the terminal may be a male terminal. The insulating cord body 820 contains one or more conducting wires (not shown in the figure) running through the cord body 820 and connecting to different ones of the female terminal conducting holes, or to different ones of one or more male terminal conducting posts in embodiments where the terminal head 810 is a male terminal. The multi-headed interchangeable head 800 may further comprise at least one other terminal 830 at one end of a different insulating cord 840. In the embodiment illustrated, terminal 830 is a male terminal for a USB power connection. However, in embodiments, the terminal head may be a female terminal. The insulating cord body 840 contains one or more conducting wires (not shown in the figure) running through the cord body 840 and connecting to different ones of the female terminal conducting holes, or to different ones of one or more male terminal posts in embodiments where the terminal head 830 is a male terminal. In embodiments, there may be a third head with yet a different terminal head. The number of heads in the multi-headed interchangeable head is not limiting on the invention.

In embodiments, the wires for the multiple heads may converge to a single terminal 850, which may be a male or a female terminal. FIG. 8B illustrates an embodiment of a male connector comprising a first set of conducting posts 860 that are square in shape, and a second set of conducting posts 870 that are triangular in shape. In embodiments, the conducting posts 860 may be connected to the wires for the A/C power head, and the conducting posts 870 may be connected to the wires for the USB power head, or vice versa.

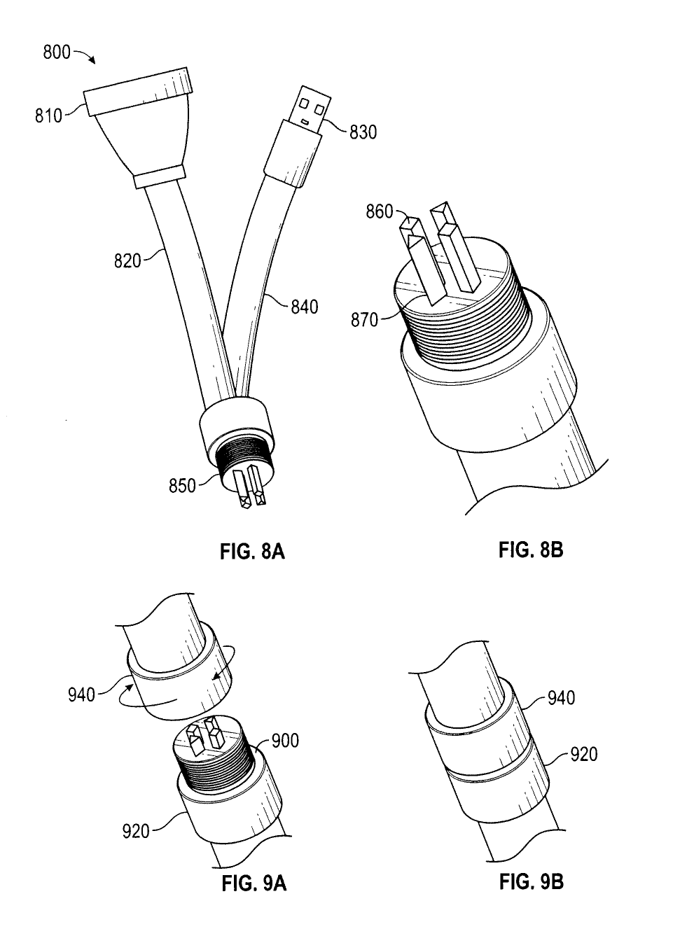

Referring to FIGS. 9A and 9B, embodiments of a connection between a base cord and an interchangeable head are illustrated. FIG. 9A illustrates the terminal end of FIG. 8B for one of the base cord and an interchangeable head, with the head portion 920 being threaded, as shown. A female terminal, such as that shown in FIG. 1B, may be used for the other of the base cord and an interchangeable head. The other terminal may comprise an internally threaded cylinder 940 extending from an end of the female terminal, and twistably attached so that a threaded engagement with the threads 920 connected to a threaded outer perimeter of the male terminal head may be made when twisted. The base cord and an interchangeable head are shown in threaded engagement in FIG. 9B. Note that an internally threaded cylinder may be used for threaded attachment to a threaded terminal head for any of the embodiments of the base cord and the interchangeable heads.

Note that in embodiments, both ends of the base cord may have male terminals. In embodiments, both ends of the base cord may have female terminals. Likewise, in embodiments both ends of the interchangeable heads may have male terminals. In embodiments, both ends of the interchangeable heads may have female terminals. In embodiment where both ends of the base cord have female terminals, a single interchangeable head may be advantageously connected. In embodiments, where the base cord has multiple sets of a male terminal posts, a single interchangeable head embodiment may comprise a female terminal with multiple set of conducting holes for mating with the multiple set of male terminal posts, but with only one set of the conducting holes connected to the one or more wires, e.g., one of the sets of holes is a dummy set.

All components, modes of communication, and/or processes described heretofore are interchangeable and combinable with similar components, modes of communication, and/or processes disclosed elsewhere in the specification. It is intended that any structure or step of an embodiment disclosed herein may be combined with other structure and or method embodiments disclosed herein to form an embodiment with this added element or step, unless a statement herein explicitly prohibits this combination.

The above-described embodiments of the present invention are merely meant to be illustrative and not limiting. Various changes and modifications may be made without departing from the invention in its broader aspects. The appended claims encompass such changes and modifications within the spirit and scope of the invention.

I claim:

1. A base cord, comprising:
an insulating cord body with a first and second ends;
a plurality of conducting wires running within the cord body from the first end to the second end;
a female terminal at least at one of the first and second ends of the cord body,
wherein the at least one female terminal comprises a plurality of different sets of one or more conducting holes, with each respective different set of one or more conducting holes connected to a different set of one or more of the conducting wires, and adapted for connection to an associated male terminal head with one or more male conducting posts that fit within the one or more conducting holes of the respective set, wherein a first one of the sets of one or more conducting holes has at least one different shape compared to one or more shapes of a second one of the sets of one or more conducting holes.

2. The integrated cord as defined in claim 1, wherein both the first and the second ends have the female terminal thereon.

3. The integrated cord as defined in claim 1, wherein the at least one female terminal comprises an internally threaded cylinder rotatably attached to an end of the female terminal, and adapted to be rotated to make threaded engagement with a threaded outer perimeter of the male terminal head.

4. The integrated cord as defined in claim 1, wherein at least one of the conducting wires is of a different type compared to the other conducting wires.

5. The integrated cord as defined in claim 5, wherein the different type comprises a different wire gauge.

6. The integrated cord as defined in claim 1, wherein the different type is one selected from the group of USB power wire, ground wire, A/C power wire, audio, video, and telephony.

7. A kit comprising:
a base cord, comprising:
an insulating cord body with a first and second ends;
a plurality of conducting wires running within the cord body from the first end to the second end;
a female terminal at least at one of the first and second ends of the cord body,
wherein the at least one female terminal comprises a plurality of different sets of one or more conducting holes, with each respective different set of one or more conducting holes connected to a different set of one or more of the conducting wires, wherein a first one of the sets of one or more conducting holes has at least one different shape compared to one or more shapes of a second one of the sets of one or more conducting holes, and
a plurality of interchangeable heads, comprising:
a first interchangeable head comprising:
an insulating first cord body with a first and second ends;
one or more conducting wires running within the first cord body from the first end to the second end;
a first male terminal head at one of the ends of the insulating cord body, with a set of one or more male conducting posts of a first one or more shapes adapted to mate with the one or more conducting holes of the first set of conducting holes in the female terminal of the base cord, wherein each conducting wire connects to a different one of the one or more male conducting posts;
a second terminal head that is male or female at the other of the ends of the insulating cord body;
a second interchangeable head comprising:
an insulating second cord body with a first and second ends;
one or more conducting wires running within the second cord body from the first end to the second end;
a third male terminal head at one of the ends of the insulating cord body, with a set of one or more male conducting posts of a second one or more shapes adapted to mate with the one or more conducting holes of the second set of conducting holes in the female terminal of the base cord, wherein each conducting wire connects to a different one of the one or more male conducting posts; and
a fourth terminal head that is male or female at the other of the ends of the insulating cord body.

8. The kit as defined in claim 7, wherein the plurality of interchangeable heads comprises a shape selected from the group of a USB connector, an A/C power connector, audio connector, video connector, and telephony connector.

9. The kit as defined in claim 7, wherein the second terminal head is a male terminal head with a set of one or more male electrical connectors with a third shape that is different from the first shape.

10. A kit comprising:
a base cord, comprising:
an insulating cord body with a first and second ends;
a plurality of conducting wires running within the cord body from the first end to the second end;
an electrical terminal at each of the first and second ends of the cord body,
wherein each of the electrical terminals is either female or male in configuration and comprises a plurality of different sets of one or more conducting holes or conducting posts, with each respective different set of one or more conducting holes or conducting posts connected to a different set of one or more of the conducting wires, wherein a first one of the sets of one or more conducting holes or conducting posts has at least one different shape compared to one or more shapes of a second one of the sets of one or more conducting holes or conducting posts, and
a single element comprising a plurality of interchangeable heads, comprising:
a first interchangeable head comprising:
an insulating first cord body with a first and second ends;
one or more first conducting wires running within the first cord body from the first end to the second end;
a first terminal head at one of the ends of the insulating first cord body, with a set of one or more male conducting posts or female conducting holes of a first set one or more shapes, wherein each of the male conducting posts or female conducting holes connects to a different one of the first conducting wires;
a second interchangeable head comprising:
an insulating second cord body with a first and second ends;
one or more second conducting wires running within the second cord body from the first end to the second end;
a second terminal head at one of the ends of the insulating second cord body, with a set of one or more male conducting posts or female conducting holes of a second set one or more shapes that has at least one different shape compared to one or more shapes of the first one of the sets of one or more conducting holes or conducting posts, wherein each of the male conducting posts or female conducting holes connects to a different one of the second conducting wires;
a single connector that receives the first set of one or more conducting wires and the second set of one or more conducting wires and comprises a single third male or female electrical terminal with a first set of one or more conducting holes or conducting posts and a second set of one or more conducting holes or conducting posts, wherein the first set of one or more conducting holes or conducting posts has at least one different shape compared to the one or more shapes of the second set of one or more conducting holes or conducting posts,
wherein the first set of one or more conducting holes or conducting posts in the single interchangeable head is adapted to mate with the first set of one or more conducting holes or conducting posts in the base cord, and the second set of one or more conducting holes or conducting posts in the single interchangeable head is adapted to mate with the second set of one or more conducting holes or conducting posts in the base cord.
